(19) United States
(12) Patent Application Publication
(10) Pub. No.: US 2014/0089082 A1
(43) Pub. Date: Mar. 27, 2014

(54) METHOD AND SYSTEM FOR ONLINE ADVERTISING

(71) Applicants: Haengju Lee, Webster, NY (US); Shanmuga-Nathan Gnanasambandam, Webster, NY (US)

(72) Inventors: Haengju Lee, Webster, NY (US); Shanmuga-Nathan Gnanasambandam, Webster, NY (US)

(73) Assignee: XEROX CORPORATION, Norwalk, CT (US)

(21) Appl. No.: 13/623,886

(22) Filed: Sep. 21, 2012

(51) Int. Cl. G06Q 30/02

(52) U.S. Cl. 705/14.45; 705/14.41; 705/14.46

(57) ABSTRACT

A computer implementable online advertising method is provided. A basic price for publishing an advertisement for a pre-specified duration is determined. A score indicative of the performance of the advertisement during the pre-specified duration is determined. Whether the score satisfies a pre-determined criterion is determined. An incentive associated with publishing the advertisement is provided to an advertiser associated with the advertisement based on the pre-determined criterion being satisfied.

### COPYRIGHT NOTICE

A portion of the disclosure of this patent document contains material that is subject to copyright protection. The copyright owner has no objection to facsimile reproduction by anyone of the patent document or the patent disclosure as it appears in the Patent and Trademark Office patent file or records but otherwise reserves all copyright rights whatsoever.

### TECHNICAL FIELD

The presently disclosed embodiments are related to online advertising. More particularly, the presently disclosed embodiments are related to sponsored search advertising.

### BACKGROUND

The Internet has become an important advertising medium. Among the various Internet advertising methods, sponsored search advertising is an important source of revenue for online publishers such as search engine providers. Sponsored search advertising allows advertisers to bid on particular user-entered search queries. On successful bidding, the advertisers display one or more advertisements relevant to the search queries in advertising slots that are prominently displayed in a results page. Every time the user clicks on the advertisement, the advertisers pay a certain amount of revenue to the publisher. The revenue of the publisher depends on the number of clicks on the advertisement, which in turn depends on the effectiveness of the advertisement. To increase the revenue, there is a need to improve the effectiveness of the advertisement.

### SUMMARY

According to aspects illustrated herein, there is provided a computer implementable online advertising method. The method comprises determining a basic price for publishing an advertisement for a pre-specified duration. The method further comprises determining a score indicative of the performance of the advertisement during the pre-specified duration and determining whether the score satisfies a pre-determined criterion. The method further comprises providing an incentive associated with publishing the advertisement to an advertiser associated with the advertisement based on the pre-determined criterion being satisfied.

According to aspects illustrated herein, there is provided a computer implementable online advertising system. The system comprises a score calculator configured to determine a score indicative of the performance of an advertisement during a pre-specified duration. The system further comprises a rule engine configured to determine an incentive associated with publishing the advertisement to an advertiser associated with the advertisement based on a determination of whether the score satisfies a pre-determined criterion. The system further comprises a price calculator configured to determine a price for publishing the advertisement during the pre-specified duration based on the incentive and a basic price for publishing an advertisement for the pre-specified duration.

According to aspects illustrated herein, there is provided a computer program product for use with a computer, the computer program product comprising a computer-readable program code embodied therein for performance-based online advertising. The computer-readable program code comprises program instruction means for determining a basic price for publishing an advertisement for a pre-specified duration. The computer-readable program code further comprises program instruction means for determining a score indicative of the performance of the advertisement during the pre-specified duration and program instruction means for determining whether the score satisfies a pre-determined criterion. The computer-readable program code further comprises program instruction means for providing an incentive associated with publishing the advertisement to an advertiser associated with the advertisement based on the pre-determined criterion being satisfied.

### BRIEF DESCRIPTION OF DRAWINGS

Various embodiments will hereinafter be described in accordance with the appended drawings provided to illustrate and not limit the scope in any manner, wherein like designations denote similar elements, and in which

FIG. 1 illustrates a system environment in which the disclosed embodiments can be implemented;

FIG. 2 is a block diagram illustrating a publishing server in accordance with at least one embodiment;

FIG. 3 is a flowchart representing a computer implementable online advertising method in accordance with at least one embodiment; and

FIG. 4 is a flowchart representing a computer implementable performance-based online advertising method in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed description given herein with respect to these figures is just for explanatory purposes as the method and the system extend beyond the described embodiments. For example, those skilled in the art will appreciate, in light of the teachings presented, recognizing multiple alternate and suitable approaches, depending on the needs of a particular application, to implement the functionality of any detail described herein, beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but not every embodiment or example necessarily includes that particular feature, structure, characteristic, property, element, or limitation. Furthermore, repeated use of the phrase “in an embodiment” does not necessarily refer to the same embodiment, although it may.

Various terms that appear in the following description have been defined below:

User: A user is a person who browses through one or more web pages of a website. In an embodiment, a user performs a search for information related to a topic of interest on a website of a search engine. In another embodiment, the user performs a search for coupons of interest on a cloud computing based platform. The user may also view an advertisement published on the website. The user may further click the advertisement to visit a website associated with the advertisement.

Publisher: A publisher corresponds to a person, an organization, or a company that owns a website and provides advertising spaces for publishing one or more advertisements on the website. Examples of such websites may include, but are not limited to, a search engine, a social networking website, a news website, and any other website that publishes advertisements. The publisher receives revenue from advertisers in exchange for placements of their one or more advertisements on the publisher's website. The publisher may be compensated in different ways, including, but not limited to flat rate fees, cost per click, cost per action, cost per lead, etc. One publisher can own a single or multiple domain web servers or websites.

Advertiser: An advertiser is a person, an organization, or a company that places one or more advertisements on a website associated with a publisher. In an embodiment, when a user clicks an advertisement published on the website associated with the publisher, the advertisement directs the user to a website associated with the advertiser. The advertiser pays the publisher for publishing his one or more advertisements and directing the one or more user to his website. Examples of websites of the advertiser may include, but are not limited to, a website associated with a company selling electronic devices, a website associated with an educational institution, a website associated with an organization providing services related to tourism, and any other website that offers products and/or services for sale.

Basic price: Basic price corresponds to a cost that an advertiser pays to a publisher to publish an advertisement at a particular location on a website associated with the publisher. The basic price includes at least one of a cost per click, a cost per action, or a cost per lead.

Cost Per Click (CPC): Cost Per Click corresponds to an amount that an advertiser pays a publisher when a user clicks an advertisement displayed on a website associated with the publisher.

Cost Per Action (CPA): Cost Per Action corresponds to an amount that an advertiser pays a publisher when a user performs one or more actions on the website associated with the advertiser in response to an advertisement.

Cost Per Lead (CPL): Cost Per Lead corresponds to an amount that an advertiser pays a publisher for each lead about a potential user provided by the publisher.

Fixed price-based mechanism: Fixed price-based mechanism corresponds to an online advertising model in which the advertiser and the publisher agree upon a fixed amount that will be paid for publishing an advertisement.

Auction-based mechanism: Auction-based mechanism corresponds to an online advertising model in which one or more advertisers bid for publishing their advertisement at a particular location on a website associated with the publisher. The publisher publishes the advertisement associated with the advertiser winning the bid on his website.

Bargaining based mechanism: Bargaining based mechanism corresponds to an online advertising model in which prices are determined through negotiation. Bargaining based mechanism includes a back-and-forth process of bargaining until an advertiser and a publisher reach a mutually agreeable price.

Reverse-auction based mechanism: Reverse-auction based mechanism corresponds to an online advertising model in which an advertiser set a price for one or more advertisements and one or more publishers compete to match or even beat the price.

Performance of an advertisement: Performance of an advertisement refers to the effectiveness of the advertisement from different perspectives, including advertisement attraction and visibility scale, user's responses and reactions, direct sales, and advertisement impacts. Performance of the advertisement is determined based on user response corresponding to the advertisement.

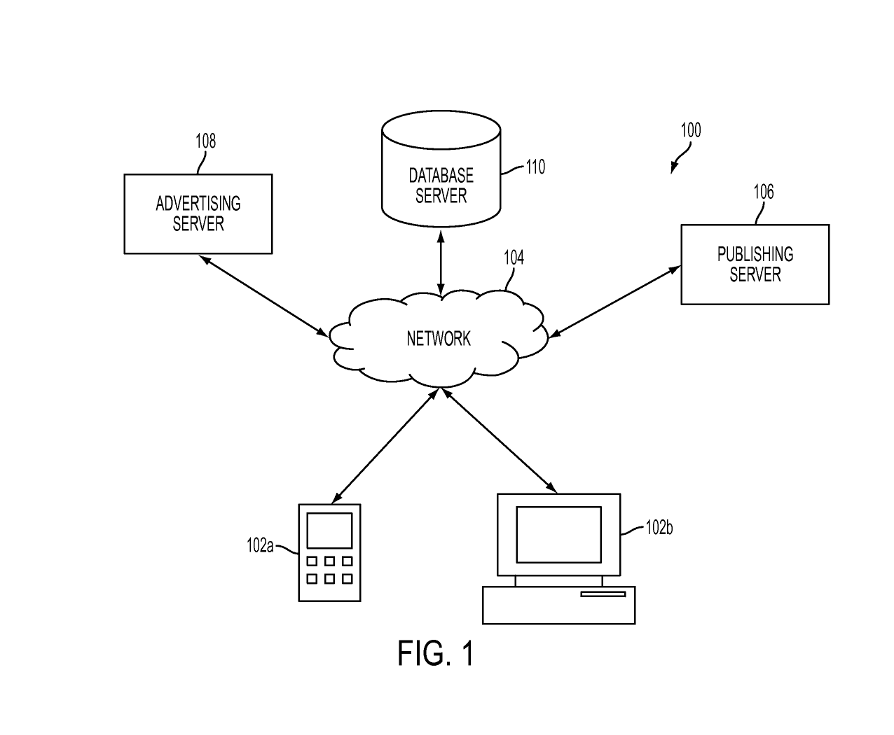

FIG. 1 is a system environment 100 in which the disclosed embodiments can be implemented. The system environment 100 includes a first user device 102a, a second user device 102b, a network 104, a publishing server 106, an advertising server 108, and a database server 110.

In an embodiment, the first user device 102a and the second user device 102b, hereinafter referred to as user device 102, correspond to a computing device through which a user can browse through one or more web pages of a website. Examples of the user device 102 may include, but are not limited to, mobile phones such as the first user device 102a, desktop computers such as the second user device 102b, laptops, televisions (TVs), tablet computers, handheld devices, Personal Digital Assistant (PDA) devices, or any other devices with hardware and software components to enable browsing of the one or more web pages. Although FIG. 1 shows only two user devices for simplicity, it may be appreciated that the disclosed embodiments can be implemented for a large number of user devices.

The network 104 corresponds to a medium through which various components of the system environment 100 communicate with each other. Examples of the network 104 may include, but are not limited to, the Internet, a Wireless Fidelity (Wi-Fi) network, a Wireless Area Network (WAN), a Local Area Network (LAN), a telephone line such as Plain Old Telephone Service (POTS), or a Metropolitan Area Network (MAN). Various components of the system environment 100 can connect to the network 104 in accordance with various wired and wireless communication protocols such as Transmission Control Protocol and Internet Protocol (TCP/IP), Customer Datagram Protocol (UDP), Hypertext Transfer Protocol (HTTP), or File Transfer Protocol (FTP).

The publishing server 106 corresponds to a computing device or a server computing device that hosts a website associated with a publisher. Examples of such websites may include, but are not limited to, shopping websites, social networking websites, news websites, gaming websites, and media sharing websites. The publishing server 106 may be implemented as a cluster or network of computing devices that jointly perform the functions of the publishing server 106. The publishing server 106 may optionally include storage media for storing data associated with the user device 102, the advertising server 108, etc. The publishing server 106 provides a location on one or more web-pages on the website to publish an advertisement, provided by the advertising server 108, for viewing by the user visiting the website. In an embodiment, the publishing server 106 publishes one or more advertisements on a webpage based on content of the webpage. In another embodiment, the publishing server 106 publishes one or more randomly selected advertisements on the webpage.

In an embodiment, the publishing server 106 corresponds to a server of a search engine. The search engine provides the user an option to search information regarding any topic. The user uses the user device 102 to communicate with the search engine. Using the user device 102, the user may enter a search query related to a topic of his interest in a search box of the search engine. The search engine presents a search result page in a display screen of the user device 102. The search result page may include a list of uniform resource locator (URL) addresses for documents relevant to the topic of the user's interest. In an embodiment, the search engine publishes one or more advertisements related to the searched topic in a sponsored section of the search results page. In another embodiment, the search engine publishes one or more one or more randomly selected advertisements in the sponsored section of the search results page. Such randomly selected advertisements may be independent of the search query entered by the user.

In another embodiment, the publishing server 106 corresponds to a server of a cloud computing-based platform. The cloud computing-based platform allows the user and one or more advertisers to upload their coupons and share them with other users. A coupon refers to an advertisement that provides a discount on a product and/or service. The cloud computing-based platform also provides the user an option to search coupons based on keywords. The user enters a keyword related to a topic of his interest in the search box of the cloud computing-based platform. The cloud computing-based platform presents a result page. The result page includes unpaid search results and paid search results. The unpaid search results include keyword related coupons that are uploaded by other users and the user. The paid search results include keyword related coupons uploaded by one or more advertisers. The cloud computing-based platform publishes the paid search results at a designated place in the result page. In addition to the keyword-based search result, the user can navigate coupon categories to find coupons of interest. A result page of this navigation also includes both the unpaid search results and the paid search results.

The publishing server 106 determines a price to be paid by the advertiser for publishing the advertisement. The publishing server 106 further determines a location in the search result page for publishing the one or more advertisements. The publishing server 106 determines the price and the location based on at least one of a fixed price-based mechanism, an auction-based mechanism, bargaining based mechanism, or a reverse-auction based mechanism. A person skilled in the art would appreciate that the price and the location for publishing the one or more advertisements may be determined using other mechanisms without departing from the inventive concepts herein. In an embodiment, the publishing server 106 provides an incentive to the advertising server 108 based on a performance of the advertisement provided by the advertising server 108.

The advertising server 108 corresponds to a computing device or a server-computing device that hosts a website associated with an advertiser. The website hosted by the advertising server 108 may offer products and/or services related to a search query entered by the user in the search box of the search engine. The website hosted by the advertising server 108 may also provide content relevant to the search query entered by the user. In an embodiment, the advertising server 108 communicates with the user device 102 and the publishing server 106 through the network 104. The advertising server 108 may be implemented as a cluster or network of computing devices that jointly perform the functions of the advertising server 108. The advertising server 108 may optionally include storage media for storing data associated with the user device 102, the publishing server 106, products and/or services offered, and one or more advertisements for publishing on the website hosted by the publishing server 106. In an embodiment, the advertising server 108 generates a bid for a specific keyword. The advertising server 108 submits the bid to the publishing server 106. On winning the bid, the advertising server 108 provides one or more advertisements for publishing to the publishing server 106. In an embodiment, the advertising server 108 provides the one or more advertisements for publishing to the server of the search engine (such as the publishing server 106). In another embodiment, the advertising server 108 provides the one or more coupons for publishing to the server of the cloud computing-based platform (such as the publishing server 106). An advertisement may include a discount on purchase of a product and/or service associated with the advertisement.

In an embodiment, the advertising server 108 receives an incentive associated with publishing the advertisement from the publishing server 106. Based on the incentive, the advertiser may improve the effectiveness of the advertisement through the advertising server 108. To improve the effectiveness, the advertiser may improve the design of the advertisement, provide attractive offers, such as more discounts to the user, and enhance the brand of product and/or service offered. Improving the effectiveness may result in enhanced performance of the advertisement.

The database server 110 corresponds to a storage device, or alternatively multiple storage devices distributively connected, that store data associated with the user device 102, the publishing server 106, and the advertising server 108. In an embodiment, the database server 110 communicates with the user device 102, the publishing server 106, and the advertising server 108 through the network 104. In another embodiment, the database server 110 may be integrated with the publishing server 106. In still another embodiment, the database server 110 may be integrated with the advertising server 108. The database server 110 can be implemented by using several technologies that are well known to those skilled in the art. Some examples of such technologies may include, but are not limited to, MySQL® and Microsoft SQL®.

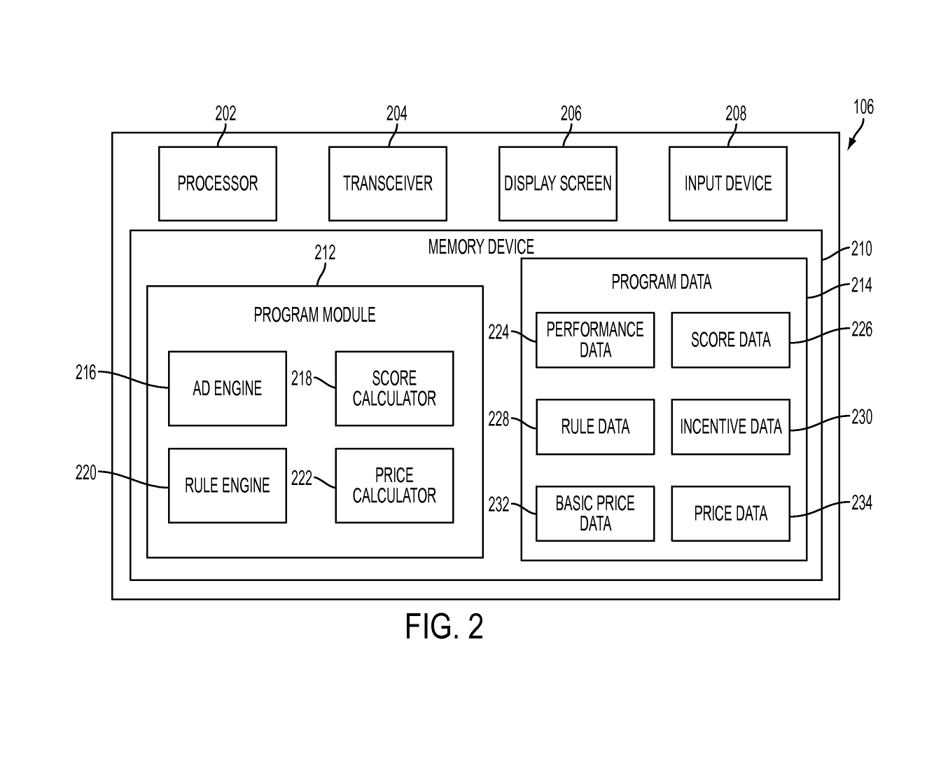

FIG. 2 is a block diagram illustrating the publishing server 106 in accordance with at least one embodiment. FIG. 2 is explained in conjunction with the system environment 100 of FIG. 1. The publishing server 106 includes a processor 202, a transceiver 204, a display screen 206, an input device 208, and a memory device 210. Further, the memory device 210 includes program module 212 and program data 214.

The processor 202 is coupled to the transceiver 204, the display screen 206, the input device 208, and the memory device 210. The processor 202 executes a set of instructions stored in the memory device 210.

The transceiver 204 transmits and receives data and messages. The transceiver 204 transmits and receives data in accordance with various known communication protocols. In an embodiment, the transceiver 204 receives the bid and the one or more advertisements from the advertising server 108 through the network 104. In another embodiment, the transceiver 204 receives the search query entered by the user through the network 104. In an embodiment, the transceiver 204 can directly receive the search query from the user device 102 and the one or more advertisements from the advertising server 108 over a wired or a wireless connection through the network 104. In an embodiment, the transceiver 204 may transmit messages and data to the user device 102 and the advertising server 108. The transceiver 204 stores the received data and messages in the program data 214.

The display screen 206 displays the search box, the result page, and the one or more advertisements. The display screen 206 can be realized through several known technologies such as, but not limited to, Cathode Ray Tube (CRT) based display, Liquid Crystal Display (LCD), Light Emitting Diode (LED) based display, and Organic LED (OLED) display technology. Further, the display screen 206 can be a touch screen that receives an input from the publisher.

The input device 208 receives a user input for controlling operations of the publishing server 106. Examples of the input device 208 may include, but are not limited to, a keyboard, a mouse, a joystick, a gamepad, a stylus, a remote control, or a touch screen.

The memory device 210 stores a set of instructions or modules, and data. Some of the commonly known memory device implementations can be, but are not limited to, Random Access Memory (RAM), Read Only Memory (ROM), Hard Disk Drive (HDD), and a Secure Digital (SD) card. The program module 212 includes a set of instructions that can be executed by the processor 202 to perform specific functions in the publishing server 106. Further, the program module 212 includes an ad engine 216, a score calculator 218, a rule engine 220, and a price calculator 222.

The program data 214 in the memory device 210 include performance data 224, score data 226, rule data 228, incentive data 230, basic price data 232, and price data 234.

The ad engine 216 is configured to publish one or more advertisements on the website hosted by the publishing server 106. In an embodiment, the ad engine 216 is further configured to determine a location in the search result page for publishing an advertisement. The ad engine 216 determines the location based on at least one of a fixed price-based mechanism or an auction-based mechanism. In an embodiment, the ad engine 216 is further configured to receive bids from the advertising server 108 and determine the location for publishing the advertisement based on the bid.

The score calculator 218 is configured to determine a score indicative of the performance of the advertisement published on the website hosted by the publishing server 106. The score indicates the performance of the advertisement during a pre-specified duration. The score corresponds to a numerical value or an event that directly measures the user response that results from the advertisement. The score calculator 218 is further configured to collect measurable performance data. Examples of the measurable performance data may include, but are not limited to, the number of clicks on the advertisement and occurrence of one or more specified actions associated with the advertisement. Examples of one or more specified actions may include, but are not limited to, a user performing an action on the website associated with the advertiser and the publisher providing a lead about a potential user. The action of the user may include, but is not limited to, adding products and/or services to a shopping cart, purchasing the products and/or services, submitting a form, and registering for a newsletter. Further, the lead about the potential user includes information such as name, address, contact details, email address, and user profile of the potential user. The score calculator 218 stores the collected performance data as the performance data 224 in the program data 214.

The score calculator 218 further processes and analyses the performance data 224. The score calculator 218 determines the score based on the processing and analysis. In an embodiment, the score calculator 218 may perform processing and analysis in real-time. In an embodiment, the score calculator 218 estimates a number of clicks on the advertisement during the pre-specified duration and calculates the score based on the estimation. The score calculator 218 stores the calculated score as the score data 226 in the program module 212.

The rule engine 220 is configured to determine an incentive associated with publishing the advertisement. The rule engine 220 determines whether the score data 226 satisfies a pre-determined criterion. The pre-determined criterion corresponds to one or more conditions or events that determine the incentive associated with publishing the advertisement. Examples of the pre-defined criterion may include, but are not limited to, number of clicks on the advertisement during the pre-specified duration exceeding a first pre-determined number, number of clicks on the advertisement during the pre-specified duration exceeding a second pre-determined number, number of users completing the transactions exceeding a certain number, number of actions performed by one or more users exceeding a defined quantity, and number of provided leads exceeding a fixed number. The pre-defined criterion is stored as rule data 228 in the program data 214. The rule engine 220 determines the incentive based on the score data 226 satisfying the pre-determined criterion.

When the score satisfies the pre-determined criterion, the rule engine 220 determines the incentive associated with publishing the advertisement. The rule engine 220 determines the incentive based on an optimized profit for publishing the advertisement. Examples of providing the incentive may include one or more of reducing a basic price associated with publishing the advertisement, providing a varying price associated with publishing the advertisement, manipulating one or more conditions associated with publishing the advertisement, or providing additional advertisement space on the website. In an embodiment, the rule engine 220 determines a first incentive associated with publishing the advertisement when the estimated number of clicks exceeds a first pre-determined number. The first incentive includes a second cost per click for each click when the number of clicks during the pre-specified time duration exceeds the first pre-determined number. The second cost per click is less than a first cost per click determined by the price calculator 222. In an embodiment, the second cost per click varies when the number of clicks exceeding the first pre-determined number increases.

In another embodiment, the rule engine 220 determines a second incentive when the number of clicks during the pre-specified duration exceeds a second pre-determined number. The second incentive includes a third cost per click. The third cost per click is less than the second cost per click. The second pre-determined number is greater than the first pre-determined number. In an embodiment, the rule engine 220 determines the first pre-determined number, the second pre-determined number, the second cost per click, and the third cost per click based on the optimized profit for publishing the advertisement. The rule engine 220 stores the incentive to be provided to the advertiser as incentive data 230 in the program module 212. The rule engine 220 provides the incentive to the advertiser associated with the advertisement.

The price calculator 222 is configured to determine a basic price for publishing the advertisement for the pre-specified duration. The price calculator 222 determines the basic price based on at least one of the fixed price-based mechanism or the auction-based mechanism. According to the fixed price-based mechanism, the price calculator 222 determines a fixed amount that the advertiser pays to the publisher. According to the auction-based mechanism, the price calculator 222 receives one or more bids from multiple advertisers to publish their advertisement at the particular location. The price calculator 222 compares the one or more bids and determines the winning bid. The ad engine 216 publishes an advertisement associated with the advertiser winning the bid. In an embodiment, the price calculator 222 determines a basic price for each click on the advertisement that the advertiser pays to the publisher. For example, the basic price for each click on the advertisement includes a first cost per click. In another embodiment, the price calculator 222 determines a basic price for each action of the one or more users. In still another embodiment, the price calculator 222 determines a basic price for each lead about the one or more users provided to the advertising server 108. The price calculator 222 stores the basic price as basic price data 232 in the program data 214.

The price calculator 222 is further configured to determine a price for publishing the advertisement during the pre-specified duration based on the incentive determined by the rule engine 220 and the basic price it determines. For example, the price calculator 222 determines a price for publishing the advertisement during the pre-specified duration based on the first cost per click and the first incentive. In an embodiment, the price for publishing the advertisement during the pre-specified duration includes the first cost per click when the number of clicks on the advertisement during the pre-specified duration is below the first pre-determined number and the second cost per click when the number of clicks during the pre-specified duration exceeds the first pre-determined number. In another embodiment, the price for publishing the advertisement during the pre-specified duration includes the first cost per click when the number of clicks on the advertisement during the pre-specified duration is below the first pre-determined number, the second cost per click when the number of clicks during the pre-specified time duration exceeds the first pre-determined number, and the third cost per click when the number of clicks during the pre-specified duration exceeds the second pre-determined number. The price calculator 222 stores the determined price as the price data 234 in the program data 214.

In operation, the price calculator 222 determines the basic price for publishing the advertisement at a particular location on the website hosted by the publishing server 106. The score calculator 218 determines the score indicative of performance of the advertisement during the pre-specified duration. The rule engine 220 determines whether the score satisfies the pre-determined criterion. When the score satisfies the pre-determined criterion, the rule engine 220 determines the incentive associated with publishing the advertisement.

It may be appreciated that the disclosed embodiments can be extended to include one or more blocks in the program module that can enable the publishing server 106 to perform additional functions. A person skilled in the art would appreciate that the one or more blocks in FIG. 2 can be combined together to form a single module that is capable of performing various functions of the publishing server 106.

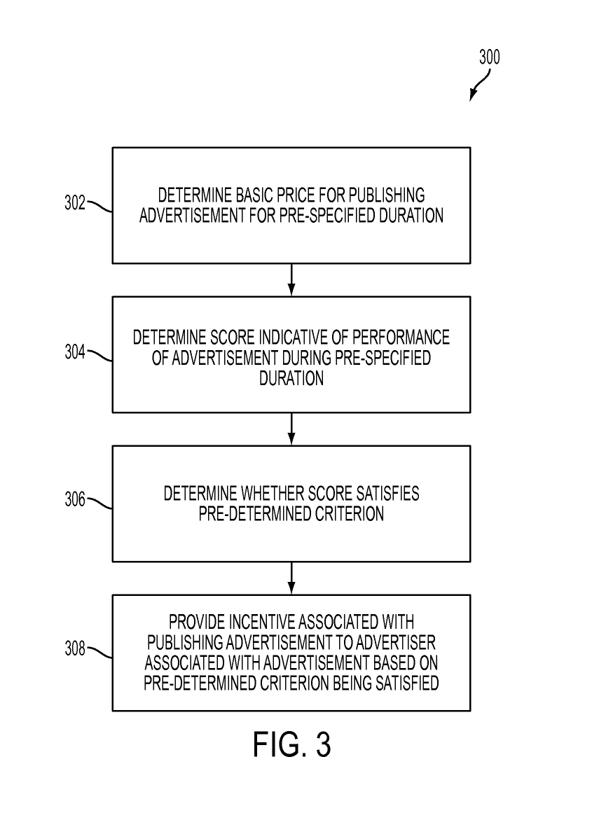

FIG. 3 is a flowchart 300 representing a computer implementable online advertising method in accordance with at least one embodiment. The flowchart 300 is described in conjunction with the block diagram of FIG. 1 and FIG. 2.

At step 302, a basic price for publishing an advertisement for a pre-specified duration is determined. The price calculator 222 determines the basic price for publishing the advertisement at a particular location on the website hosted by the publishing server 106. In an embodiment, the price calculator 222 determines the basic price based on the fixed price-based mechanism. In another embodiment, the price calculator 222 determines the basic price based on the auction-based mechanism. When the user performs a search on the publishing server 106, the ad engine 216 publishes the advertisement at the particular location on the result page. The advertisement may include a discount on purchase of the associated product and/or service.

At step 304, a score indicative of performance of the advertisement during the pre-specified duration is determined. The score calculator 218 determines the score based on at least one of the number of clicks on the advertisement or occurrence of the one or more specified actions associated with the advertisement.

At step 306, it is determined whether the score satisfies the pre-determined criterion. The rule engine 220 determines at least one of whether the number of clicks on the advertisement during the pre-specified duration exceeds a first pre-determined number, whether the number of clicks on the advertisement during the pre-specified duration exceeds a second pre-determined number, whether the number of user completing the transactions exceeds a certain number, whether the number of actions performed by the user exceeds a defined quantity, or whether the number of the provided leads exceeds a fixed number.

At step 308, an incentive associated with publishing the advertisement to the advertiser associated with the advertisement is provided based on the pre-determined criterion being satisfied. The rule engine 220 determines whether the score satisfies the pre-determined criterion. When the score satisfies the pre-determined criterion, the rule engine 220 determines the incentive associated with publishing the advertisement. The rule engine 220 determines the incentive based on an optimized profit for publishing the advertisement. The rule engine 220 provides the incentive to the advertising server 108 associated with the advertisement.

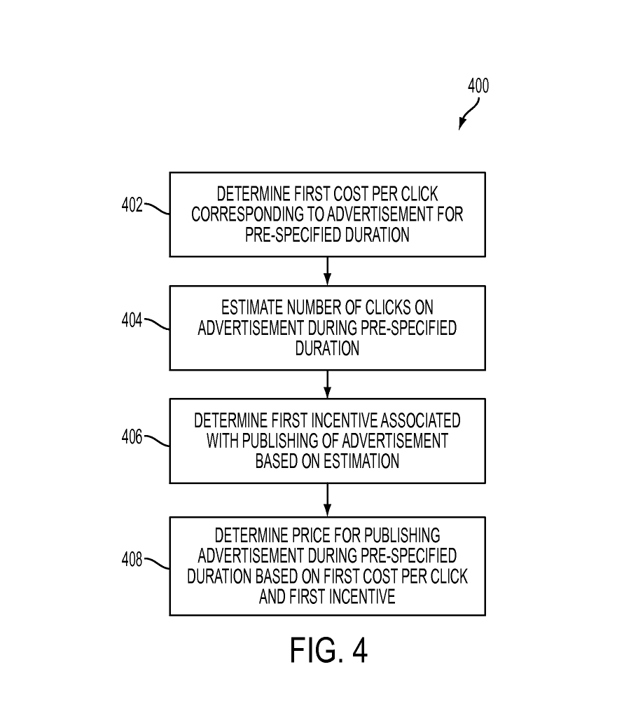

FIG. 4 is a flowchart 400 representing a computer implementable method for providing incentives for online advertising in accordance with at least one embodiment. The flowchart 400 is described in conjunction with the block diagram of FIG. 1 and FIG. 2.

At step 402, a first cost per click for publishing the advertisement for a pre-specified duration is determined. The price calculator 222 determines the first cost per click for publishing the advertisement at a particular location on the website hosted by the publishing server 106. In an embodiment, the price calculator 222 determines the first cost per click based on the fixed price-based mechanism. In another embodiment, the price calculator 222 determines the first cost per click based on the auction-based mechanism. Based on the determined first cost per click, the ad engine 216 publishes the advertisement at the particular location on a website hosted by the publishing server 106. In an embodiment, the ad engine 216 publishes the advertisement at the particular location on the result page in response to a search performed by the user on the search engine. In another embodiment, the ad engine 216 publishes coupons on the result page in response to a search performed by the user on the cloud computing-based platform. The advertisement may include a discount on purchase of the associated product and/or service.

At step 404, number of clicks on the advertisement during the pre-specified duration is estimated. The number of clicks on the advertisement depends on at least one of a location of the advertisement on the website or the discount provided by the advertisement.

At step 406, a first incentive associated with publishing the advertisement based on the estimation at step 404 is determined. The rule engine 220 determines whether the estimated number of clicks satisfies a pre-defined criterion. In an embodiment, the pre-defined criterion is that the number of clicks on the advertisement during the pre-specified duration should exceed a first pre-determined number. The rule engine 220 determines whether the estimated number of clicks exceeds the first pre-determined criterion. If the estimated number of clicks exceeds the first pre-determined number, the rule engine 220 determines an incentive associated with publishing the advertisement. In an embodiment, the incentive includes a first incentive. The first incentive includes a second cost per click for each click when the number of clicks during the pre-specified duration exceeds the first pre-determined number. The second cost per click is less than the first cost per click. In another embodiment, the incentive includes a second incentive when the estimated number of clicks during the pre-specified duration exceeds a second pre-determined number. The second incentive includes a third cost per click. The third cost per click is less than the second cost per click. The second pre-determined number is greater than the first pre-determined number.

At step 406, a price for publishing the advertisement is determined based on the first cost per click and the first incentive. The price calculator 222 determines the price for publishing the advertisement at the particular location for the pre-specified duration. The price calculator 222 determines the price based on the first cost per click and the first incentive. In an embodiment, the price for publishing the advertisement includes the first cost per click when the number of clicks on the advertisement during the pre-specified duration is below the first pre-determined number. The price further includes the second cost per click when the number of clicks during the pre-specified duration exceeds the first pre-determined number. In another embodiment, the price for publishing the advertisement during the pre-specified duration further includes the third cost per click when the number of clicks during the pre-specified duration exceeds the second pre-determined number.

For example, the advertising server 108 provides an advertisement that includes a discount of 20% on purchase of the associated product. The price calculator 222 determines a first cost per click at 60 cents for publishing the advertisement at a particular location on a website hosted by the publishing server 106. Based on the location and the discount, the score calculator 218 estimates 100 clicks on the advertisement. If the number of clicks exceeds 100, then the rule engine 220 determines an incentive for publishing the advertisement. Since the estimated number of clicks is 100, no incentive is provided to the advertising server 108. In order to receive the incentive, the advertising server 108 may improve the effectiveness of the advertisement. The advertising server 108 may increase the discount from 20% to 25% to attract more users. Based on the new discount and the location, the score calculator estimates 150 clicks on the advertisement. Since the number of clicks on the advertisement that include a 25% discount exceed 100, the rule engine 220 provides a first incentive, to reduce the first cost per click and provides a second cost per click at 30 cents for each click that exceeds 100 clicks. Hence, the price for publishing the advertisement that includes a 25% discount is 60 cents for each click below 100 clicks and 30 cents per click for each click exceeding 100 clicks.

In another example, the rule engine 220 may provide a second incentive, such as reducing the second cost per click and providing a third cost per click at 20 cents for each click that exceeds 250 clicks. In such a case, the price for publishing the advertisement is 60 cents for each click below 100 clicks, 30 cents per click for each click that lies between 100 and 250 clicks, and 20 cents for each click that lies exceeds 250 clicks. Based on the incentives, the advertiser may further increase the discount from 25% to 30% so that more users click the advertisement.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer-readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, DOS', ‘Android’, ‘Symbian’, ‘Windows’, ‘iOS’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Those skilled in the art will appreciate that any of the foregoing steps and/or system modules may be suitably replaced, reordered, or removed, and additional steps and/or system modules may be inserted, depending on the needs of a particular application, and that the systems of the foregoing embodiments may be implemented using a wide variety of suitable processes and system modules and are not limited to any particular computer hardware, software, middleware, firmware, microcode, etc.

The method, system, and computer program product, as described above have numerous advantages. The various embodiments propose a method for providing incentives for online advertising. It will be appreciated by a person skilled in the art that the disclosed embodiments motivate an advertiser to exert efforts to increase the effectiveness of his one or more advertisements. The publisher provides an incentive for subsidizing (or sharing) the cost of the efforts. The disclosed embodiments increase the publisher's revenue that depends on the number of clicks. When the advertiser makes the advertisement more attractive, the number of users clicking on the advertisement increases. Thus, the publisher's revenue also increases. The disclosed embodiments may further increase the advertiser's revenue that depends on the number of users visiting the advertiser's website. When the advertisement is attractive, more users visit the advertiser's website. Thus, probability of sale of products and/or services offered by the advertiser increases.

Various embodiments of the computer implementable online advertising have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer implementable online advertising method comprising:
determining a basic price for publishing an advertisement for a pre-specified duration;
determining a score indicative of performance of the advertisement during the pre-specified duration;
determining whether the score satisfies a pre-determined criterion; and
providing an incentive associated with publishing the advertisement to an advertiser associated with the advertisement based on the pre-determined criterion being satisfied.

2. The computer implementable online advertising method of claim 1, wherein the basic price is determined based on at least one of a fixed price-based mechanism, an auction-based mechanism, bargaining based mechanism, or a reverse-auction based mechanism.

3. The computer implementable online advertising method of claim 1, wherein the basic price comprises at least one of a cost per click, a cost per action, and a cost per lead.

4. The computer implementable online advertising method of claim 1, wherein the score is determined based on at least one of a number of clicks on the advertisement and occurrence of one or more specified actions associated with the advertisement.

5. The computer implementable online advertising method of claim 4, wherein the one or more specified actions comprises at least one of adding products and/or services to a shopping cart, purchasing the products and/or services, submitting a form, registering for a newsletter, or providing a lead about a potential user.

6. The computer implementable online advertising method of claim 1, wherein providing the incentive comprises one or more of reducing the basic price, providing a varying price associated with the advertisement, manipulating one or more conditions associated with publishing the advertisement, and providing additional advertisement space.

7. The computer implementable online advertising method of claim 1, wherein the basic price comprises a first cost per click when number of clicks during the pre-specified duration is below a first pre-determined number.

8. The computer implementable online advertising method of claim 7, wherein the incentive comprises a first incentive when the number of clicks during the pre-specified duration exceeds the first pre-determined number, the first incentive comprising a second cost per click, wherein the second cost per click is less than the first cost per click.

9. A computer implementable performance based online advertising method comprising:
determining a first cost per click for publishing an advertisement for a pre-specified duration;
estimating a number of clicks on the advertisement during the pre-specified duration;
determining a first incentive associated with publishing the advertisement based on the estimation, the first incentive comprising a second cost per click for each click when the number of clicks during the pre-specified duration exceeds a first pre-determined number, wherein the second cost per click is less than the first cost per click; and
determining a price for publishing the advertisement during the pre-specified duration based on the first cost per click and the first incentive.

10. The computer implementable performance based online advertising method of claim 9, wherein the second cost per click varies when the number of clicks exceeding the first pre-determined number increases.

11. The computer implementable performance based online advertising method of claim 9 further comprising determining a second incentive when the number of clicks during the pre-specified duration exceeds a second pre-determined number, the second incentive comprising a third cost per click, wherein the third cost per click is less than the second cost per click and the second pre-determined number is greater than the first pre-determined number.

12. The computer implementable performance based online advertising method of claim 11, wherein the first pre-determined number, the second pre-determined number, the second cost per click, and the third cost per click are determined based on an optimized profit for publishing the advertisement.

13. A publishing server of an online advertising system comprising:
a score calculator configured to determine a score indicative of performance of an advertisement during a pre-specified duration;
a rule engine configured to determine an incentive associated with publishing the advertisement to an advertiser associated with the advertisement based on a determination of whether the score satisfies a pre-determined criterion; and
a price calculator configured to determine a price for publishing the advertisement during the pre-specified duration based on the incentive and a basic price for publishing an advertisement for the pre-specified duration.

14. The publishing server of claim 13, wherein the price calculator is further configured to determine the basic price based on at least one of a fixed price-based mechanism, an auction-based mechanism, bargaining based mechanism, or a reverse-auction based mechanism.

15. The publishing server of claim 13 further comprising an ad engine configured to publish the advertisement on a website hosted by the publishing server.

16. A computer program product for use with a computer, the computer program product comprising a computer readable program code embodied therein for performance based online advertising, the computer readable program code comprising:
program instruction means for determining a first cost per click for publishing an advertisement for a pre-specified duration;
program instruction means for estimating a number of clicks on the advertisement during the pre-specified duration;
program instruction means for determining a first incentive associated with the advertisement based on the estimation, the first incentive comprising a second cost per click when the number of clicks during the pre-specified duration exceeds a first pre-determined number, wherein the second cost per click is less than the first cost per click; and
program instruction means for determining a price for publishing the advertisement during the pre-specified duration based on the first cost per click and the first incentive.

17. A computer program product for use with a computer, the computer program product comprising a computer readable program code embodied therein for performance based online advertising, the computer readable program code comprising:
program instruction means for determining a basic price for publishing an advertisement for a pre-specified duration;
program instruction means for determining a score indicative of performance of the advertisement during the pre-specified duration;
program instruction means for determining whether the score satisfies a pre-determined criterion; and
program instruction means for providing an incentive associated with publishing the advertisement to an advertiser associated with the advertisement based on the pre-determined criterion being satisfied.
